(19) United States
(12) Patent Application Publication
(10) Pub. No.: US 2025/0171370 A1
(43) Pub. Date: May 29, 2025

(54) ADDITIVE OR SEALING COMPOSITION FOR CEMENTITOUS COMPOSITIONS, CEMENTITIOUS COMPOSITION, METHODS OF MANUFACTURING THE SAME, AND METHODS OF PREPARING A CEMENTITIOUS STRUCTURE AND TREATING A SURFACE THEREOF

(71) Applicant: Construction Research & Technology GmbH, Trostberg (DE)

(72) Inventors: Xiaohui HOU, Shanghai (CN); Sunil BAUCHKAR, Shanghai (CN); Bei HE, Shanghai (CN); Gulnihal AYKAN, Dubai (AE)

(21) Appl. No.: 18/725,747

(22) PCT Filed: Dec. 21, 2022
(86) PCT No.: PCT/EP2022/087351

§ 371 Date: Jun. 28, 2024

(30) Foreign Application Priority Data
Dec. 28, 2021 (WO) PCT/CN2021/142082

(51) Int. Cl. C04B 40/00; C04B 18/14; C04B 22/10; C04B 24/16; C04B 24/24; C04B 24/26; C04B 24/32; C04B 24/38; C04B 28/04; C04B 41/45; C04B 41/48; C04B 41/63; C04B 103/40; C04B 103/44; C04B 103/65

(52) U.S. Cl. CPC C04B 40/0039; C04B 18/146; C04B 22/10; C04B 24/166; C04B 24/243; C04B 24/2694; C04B 24/32; C04B 24/38; C04B 28/04; C04B 41/4539; C04B 41/4811; C04B 41/4823; C04B 41/483; C04B 41/4896; C04B 41/63; C04B 2103/408; C04B 2103/44; C04B 2103/65

(57) ABSTRACT

Disclosed is an aqueous additive or sealing composition for cementitious compositions comprises a water-soluble salt of carbonate or hydrogen carbonate, a silica-based material, a specifically selected dispersant, at least one specifically selected thickening agent, and water. Furthermore, a method of manufacturing the aqueous additive or sealing composition, a cementitious composition comprising a hydraulic cementitious binder, a mineral aggregate, the aqueous additive composition, and optionally water and its preparation method is described. Moreover, a method of treating a surface of a cementitious structure by applying the aqueous additive or sealing composition on a surface of a cementitious structure as surface treatment agent or coating material is disclosed. The disclosed additive and sealing composition can be used as liquid crystalline waterproofing admixture composition in several applications.

### TECHNICAL FIELD

The present disclosure generally relates to an aqueous additive or sealing composition for cementitious compositions, cementitious compositions including the additive or sealing composition, a method of manufacturing the additive or sealing composition, a method of preparing a hardened cementitious structure prepared from the cementitious composition comprising the aqueous additive composition, and a method of treating a surface of a cementitious structure using the aqueous sealing composition. The present disclosure is more particularly directed to an aqueous additive or sealing composition which can be used as crystalline waterproofing admixture for cementitious compositions or as crystalline waterproofing sealing agent for cementitious structures.

### BACKGROUND

Concrete compositions are prepared from a mixture of hydraulic cement (for example, Portland cement), supplementary cementitious materials (for example, fly ash, granulated ground blast furnace slag (GGBS) and silica fume) aggregate and water. The aggregate used to make concrete compositions typically includes a blend of fine aggregate such as sand, and coarse aggregate such as stone. Alkali-aggregate reaction (“AAR”) is a chemical reaction that occurs between the reactive components of the aggregate and the hydroxyl ions from the alkaline cement pore solution present in the concrete composition. Most of the most common alkali-aggregate reactions that occur between the aggregate and alkali hydroxide is the alkali-silica reaction (“ASR”) in which the hydroxyl ions from the alkaline cement pore solution react with reactive forms of silica from the aggregate. The result of the alkali-silica reaction is the formation of a hygroscopic alkali-silica gel.

It is generally accepted that concrete is a porous material and cannot be an absolutely waterproof or impermeable material. Capillary channels, mini pores, mini cracks, air voids, and even bigger cracks may exist not only on the surface but also inside the structure of concrete. Because of these factors, water can enter concrete through capillary absorption, migrate from one place to another through various channels and penetrate deep inside the structure. In a worse case, water can penetrate through the whole structure and leads to leakage.

Besides, various internal and external factors may also cause cracks in concrete, which is one of the universal problems to be solved in the construction field. The cracks may not only affect the structure appearance, but also bring detrimental effects to concrete durability and the service life. Well-known factors include various shrinkages (like plastic shrinkage, autogenous shrinkage, drying shrinkage), expansions (due to existence of expansive agents, sulfate attack, freeze and thaw cycles. Alkali Silica Reaction (ASR) and corrosions to reinforcement), thermal cracks, subjection to restrained conditions, subjection to external collisions, vibrations and pressures, and so forth.

When new cracks are generated, more channels are created to facilitate water penetration inside the concrete. An effective solution to let concrete be more water impermeable or waterproof is to use crystalline waterproofing admixtures, as a type of permeability reducing admixtures (PRA). Crystalline waterproofing admixtures are widely used in concrete and mortar for several decades in order to heal cracks or close voids in concrete or mortar structures. Nowadays, most of the crystalline waterproofing products are in powder form and usually are added to the concrete at the time of batching. It is generally understood that such products are based on calcium silicate cement, activated mineral additives, which may react with water and the hydration products of cement and form needle-shape crystals within concrete structures, especially capillaries, pores, and hairline cracks of the concrete mass. As most of such crystals, mostly based on calcite, are insoluble in water, they could bridge the cracks, seal them and reduce the free movement channels of water and other liquids such as those containing various ions (C⁻ and SO₄²⁻). Those chemical liquids are known to be harmful for hardened concrete structures because they may negatively cause corrosion to the reinforced steels or cause expansion. The crystalline waterproofing admixtures improve these characteristics, but the powder products may easily cause environment and health impacts during their handling.

Therefore, what is still needed in the art is a crystalline waterproofing admixture composition, which can better be handled during its usage and being based on components that are readily available and cost-effective. Hence, an objective of this application is to provide improved crystalline waterproofing admixture compositions being more effective in waterproofing and self-healing properties of concrete or mortar as compared to the proposed solutions currently known in the art.

### SUMMARY

According to a first aspect, an aqueous additive or sealing composition for cementitious compositions comprises a water-soluble salt of carbonate or hydrogen carbonate, a silica-based material, a dispersant selected of one or more polycarboxylate ethers, polyaryl ethers, and beta-naphthalenesulfonate formaldehyde polycondensates and their grafted derivates, or any combination thereof, at least one thickening agent selected from polymeric poly alcohols such as polysaccharides, polyanionic thickening agents, and neutral synthetic thickening agents, and water. In some embodiments, the dispersant may be omitted, especially, if the stability of the composition is sufficiently high for the intended use.

According to a further aspect, a method of manufacturing an aqueous additive or sealing composition for cementitious compositions according to the first aspect comprises mixing a water-soluble salt of carbonate or hydrogen carbonate, a silica-based material, a dispersant, at least one thickening agent and water, thereby providing an aqueous suspension thereof. The thickening agent may be selected from polymeric polyalcohols, such as polysaccharides, polyanionic thickening agents, and neutral synthetic thickening agents to obtain an aqueous additive or sealing composition for cementitious compositions having the desired waterproofing and self-healing properties. The dispersant may comprise one or more polycarboxylate ethers, polyaryl ethers, and beta-naphthalenesulfonate formaldehyde polycondensates, sulfonated ketone-formaldehyde condensates, lignosulfonates, melamines, and their grafted derivates, or any combination thereof.

In a further aspect, a cementitious composition comprises a hydraulic cementitious binder, a mineral aggregate, the aqueous additive composition according to the first aspect, and optionally water. The aqueous additive composition may be used as an admixture composition to provide the cementitious composition, when hardened, with good waterproofing and self-healing properties.

According to yet a further aspect, a method of preparing a cementitious structure comprises preparing a cementitious composition including the aqueous additive composition according to the first aspect, placing the prepared cementitious composition at a desired location such as a suitable mold or an accordingly prepared surface space, and allowing the cementitious composition to harden. The hardened cementitious composition is, thus, provided with good waterproofing and self-healing properties.

In a further aspect, a method of treating a surface of a cementitious structure is described, which comprises at least the steps of applying the aqueous additive or sealing composition according to the first aspect on a surface of a cementitious structure as surface treatment agent or coating material, wherein the aqueous additive and sealing composition is used as a sealing composition in a sufficient amount to provide good waterproofing and self-healing properties to cementitious structures when hardened or during the hardening. “Applying on” can mean in this context also exposing the structure to moisture (like sprayed water or fog), or it could also mean placing the cementitious structure in a container filled with water and the respective sealing composition as disclosed herein.

### DETAILED DESCRIPTION

Described herein is an aqueous additive or sealing composition for cementitious compositions which can easily be handled during its usage. The additive or sealing composition comprises an aqueous mixture of a water-soluble salt of carbonate or hydrogen carbonate, a silica-based material, a dispersant, and at least one thickening agent. Thus, the additive or sealing composition as described herein is a composition which can be used as a liquid crystalline waterproofing admixture for concrete or mortar mixtures or as a surface treating agent, so called sealing agent, for hardened or to be hardened concrete or mortar surfaces of cementitious structures. The composition, therefore, may comprise a water content which is suitably adapted to the usage thereof, namely as admixture in a cementitious composition or as a sealing agent for surface treatment of cementitious structures, for example. The good flowability of the additive and sealing composition makes the composition suitable for usages in construction system area such as grout, flooring, waterproofing, and so forth, and underground construction area like shotcrete, for example. In any of these usages, the good flowability provides the users more convenience during handling, feeding, dosing, and storing compared to the commonly used powdered admixtures. As the liquid additive and sealing composition can be handled free of dust, the working environment will be much cleaner, healthier and safer compared to the powdered admixtures. An additional advantage of the liquid additive and sealing composition is that it is easier to be homogenized into the concrete and/or mortar compositions than common powdered admixtures because of the homogeneity in the slurry mixture.

Illustrative embodiments of the additive or sealing composition comprise at least one water-soluble salt of a carbonate or hydrogen carbonate. Water soluble in the context of this application does mean a solubility in water which is higher than that of calcium carbonate, for example more than 10 g/l, particularly, about 10-1,200 g/l. Exemplified embodiments for suitable water-soluble salts are carbonates or hydrogen carbonates selected from the group consisting of carbonates or hydrogen carbonates of sodium, potassium, lithium, and ammonium, and any mixture thereof.

The water-solubility of the salt component may be high enough to generate soluble carbonates or hydrogen carbonates, more particularly solubilized carbonate or hydrogen carbonate anions, in the aqueous cementitious composition during the hardening of the concrete or mortar. If the concrete or mortar structure is exposed to moisture, placed in a humid environment, or placed underwater, for example, soluble carbonates or hydrogen carbonates may react with calcium cations from the pore solutions in voids and pores and cracks within the hardened structure, for example at the construction site, and form water insoluble sediments. In addition, the silica based materials may also react with the calcium hydroxide from the pore solutions to generate additional calcium silicate hydrates to impart higher impermeability and additional strength to the concrete. Hence, parts of the compounds of the composition are active reactants and are liable to be converted into insoluble salts, for example when they are combined with calcium cations solved in the aqueous cementitious composition or react with the moisture in fresh concrete. Such reactions may be used to block or self-heal mini pores or cracks during hardening of the concrete or mortar. In addition, the concrete treated with the additive or sealing composition once being damaged, the same active compounds react with water and moisture permeating into the cracks of the already hardened cementitious structure and form insoluble crystalline deposits to seal the cracks. Thus, the formation of insoluble crystalline calcium salts such as calcium carbonate, or calcium hydrogen carbonate, or mixed crystals with other anions or cations comprised in the cementitious composition near the surface of pores or cracks leads to insoluble deposits. Typically, calcite is the main component of the generated crystalline structures. These crystalline deposits seal capillary pores and also heal cracks within the cementitious structures or at the surfaces thereof. The ability of healing cracks has been observed up to about 1.0 mm, particularly at cracks with a width of up to about 0.7 mm, and more particularly, up to 0.5 mm.

The same effect of self-healing property can be observed with the additive and sealing composition when being used as surface treating agent of already hardened cementitious structures made of concrete or mortar, for example. During the treatment of the surface of the cementitious structure by applying an aqueous composition on it, insoluble crystalline deposits of calcium carbonates or hydrogen carbonates are formed in the pores or mini cracks of the surface of the structures. Thereby the pores or cracks are healed by filling them with the crystalline deposits over the time and hardening. The healed cracks usually show a similar hardness as the concrete or mortar after a treating time of about 1 to 4 weeks in a water bath containing the additive and sealing composition. Good results have been achieved by a water curing treatment of split and rejoined mortar molds with a crack size of about 0.5 mm within about 7 to 40 days, more particularly, about 10 to 30 days, for instance about 25 to 28 days. Within this time in a water bath, crystalline deposits in the cracks are formed, which are mainly based on insoluble calcium carbonate or hydrogen carbonate crystalline structures. Mixed crystalline structures with magnesium or sulfur components, preferably sulfate, or other water-insoluble mixtures may be admixed in these crystalline deposits as well Thus, the herein described additive and sealing composition preferably is used as admixture for cementitious compositions for the use in humid atmospheres or in underwater construction sites. Sufficient humidity is necessary for the self-healing property because the water-soluble salts contained in the composition need a sufficient amount of water/humidity for being solved and taking part in the crystal growth of insoluble crystalline structures within the pores and channels of the concrete or mortar mass.

More particularly, the additive and sealing composition can preferentially be used as a dual mechanism high performance liquid crystalline waterproofing admixture for cementitious compositions. Dual mechanism means in the context of the application that the silica-based materials like silica fume may block the mini pores or cracks, including the voids of the amorphous concrete or mortar structure, while the soluble salts of carbonate or hydrogen carbonate may form insoluble crystals with Ca²⁺ in the concrete pore solutions and provide the self-healing function as described above. After being added to the cementitious composition, such as concrete or mortar, it may block or self-heal mini pores and/or cracks therein as described above. Moreover, blocking pores and healing cracks in the hardening or just hardened concrete or mortar reduces the water permeability thereof with no or negligible negative influence on the fresh or hardened properties of concrete or mortar. The water permeability is caused by the densification of concrete matrix, thus leading to a high impermeability for water. The water-impenneability can be measured by testing the water's maximum penetration depth of finished concrete or mortar cubes, for example.

According to an embodiment, the silica-based material of the liquid additive or sealing composition is comprised as filler material or densification material because it may block the mini pores and voids in the concrete or mortar compositions. Illustrative embodiments are pozzolans such as silica fume or fly ash, fumed silica, blast furnace slag, particularly ground granulated blast furnace slag (GGBS), rice husk ash and metakaolin. For example, silica fume is a fine amorphous particulate material obtained as by-product from the production of silicon and ferrosilicon alloys in an electric arc furnace. The silica-based material, such as silica fume, for example, improves concrete mid age and late age compressive strength. In addition, the presence of silica fume, for example, improves the cohesiveness of concrete and at the same time reduces the water permeability of concrete or mortar.

The chemical composition of the silica-based material meets at least a SiO₂ content of more than about 50 weight percent. For example, if silica fume or fumed silica is used, the SiO₂ content preferably is more than about 80 weight percent. According to other illustrative embodiments, the chemical composition of the silica-based material is greater than about 85 weight percent silica, more particularly, greater than about 90 weight percent silica, while the remainder is composed of other oxides of metals or transition metals and impurities. The other oxides or impurities may be calcia (calcium oxide, chemical formula CaO), alumina (aluminum oxide, chemical formula Al₂O₃), iron oxide and mixtures of these oxides. In case metakaolin or fly ash are used, exemplified SiO₂ contents of more than about 50 weight percent are mentioned.

If the silica-based material is used in the form of a powder, the particles of silica-based material may exhibit a certain granularity, narrow particle size distribution, large surface area, and bulk density. The particles of silica-based material preferably are selected of particles having a particle size between about 1 to 1000 nm. A narrow particle size distribution within this general particle size range is preferred for particle dispersion within an aqueous slurry admixture for usage in the additive or sealing composition as describe herein. However, sometimes the exact particle size of silica-based materials such as silica fume or also called micro silica are hardly to be estimated because of aggregate formation. Therefore, usually other parameters like the BET surface are more characteristic for determining these materials. Preferably, the particles of silica-based material may exhibit a BET surface area (measured based on ASTM C1240-10) in the range of about 1 to about 30 m²/g, particularly about 10 to about 30 m²/g, for instance 15 m²/g or more. Particularly useful silica-based material particles have a measured BET surface area in the range of about 20 to about 23 m²/g. Moreover, the silica-based material may have a bulk density between about 100 to 800 kg/m³, particularly, about 200 to about 380 kg/m³ (e.g. undensified silica fume) or about 500 to about 700 kg/m³ (e.g. densified silica fume). The bulk density is defined as the mass of the many particles of the material divided by the total volume they occupy. Thereby, the total volume includes particle volume, inter-particle void volume, and internal pore volume. The parameter of the dry, bulk density of a powder is thus inversely related to the porosity of the powder identifying a certain granularity of the particles therein. However, as the bulk density is not an intrinsic property of the material, it may vary and may be outside the preferred ranges given above.

In some embodiments, the silica-based material may be further characterized by a moisture content of about 3.0 weight percent or less (ASTM C311-02) and/or a loss on ignition of 6.0% or less (ASTM C311-02). For instance, specific examples of silica-based materials have a moisture content of about 1.0 weight percent or less and a loss on ignition of about 3% or less. These parameters are mere optional, while the particle size or the specific surface area may be more important as a greater surface area or a certain particle size distribution and lower particle sizes at all may influence the reactivity of the used silica-based material.

In some embodiments, the additive or sealing composition may comprise a dispersant for obtaining a stable slurry admixture. One or more different dispersant types may be selected as will be described hereinafter. The dispersant may be comprised in the composition for achieving a suitable stability of the water suspension or slurry mixture during the storage and use of the composition. Depending on the other components of the composition, the dispersant may be omitted in some examples, especially, in case the stability is high enough for the intended use or homogeneity may be recovered by remixing shortly before the use.

According to certain embodiments, the additive or sealing composition comprises at least one thickening agent. “At least one” does mean that a combination of two or more different thickening agents may be contained in the composition. The thickening effect may be triggered by an activating agent for the thickener. For example, and without limitation, the thickening effect may be triggered by a change in the pH of the liquid additive or sealing composition containing the thickener and the activating agent. Alternatively, the thickener may be activated by the admixture into the cementitious composition, for example, by increasing the pH in this generated mixture, resulting in a thickening of the mixture.

Illustrative embodiments of those thickening agents are polymeric polyalcohols, more precisely polysaccharides, such as xanthan gum, diutan gum, guar gum, starch, cellulose, welan gum, pullulan. In addition, those polymeric polyalkohols may be natural polymeric polyalcohols such as polysaccharides or synthetic polymeric polyalcohols. Exemplified synthetic polymeric polyalcohols may be modified by derivatization of one or more of the free hydroxy groups such as in hydroxypropyl cellulose or by graft polymerization. Further illustrative embodiments of thickening agents are polyanionic thickening agents such as polycarboxylic acids and their salts, for example, poly (methyl methacrylate) (PMMA), or 2-acrylamido-2-methylpropane sulfonic acid (AMPS) based polymers or copolymers. Suitable polycarboxylic acids are for example poly(meth)acrylic acid or copolymers of (meth)acrylic acid with maleic acid, maleic anhydride or any other copolymerizable carboxylic monomers. The polycarboxylic acid based thickening agents preferably are selected of such types having a carbon-containing backbone without side chains comprising polymeric structures. Preferably the polycarboxylic based thickening agents do not comprise poly (alkylene oxide) units. The polyanionic thickening agents may be salt sensitive and more preferably used in low ion strength systems. The neutral synthetic thickening agents, especially those obtained from polymerization of olefin type monomers, preferably from radical polymerization of ethylenically unsaturated monomers, may be less salt sensitive and good at high pH environments. Examples of neutral synthetic thickening agents may be polymers or copolymers based on polyacrylamide and/or polyvinyl alcohol.

According to another embodiment, the aqueous additive or sealing composition comprises the above-identified main components and, if intended, the optional further components suspended in the form of a slurry. Thereby, some of the components may be in liquid form or soluble in water. Other components may be insoluble in water and, thus, mixed into the composition in powder form, thus, forming a suspension of the insoluble components in the liquid composition. The thus obtained liquid crystalline waterproofing admixture can easily be handled and does not cause environment and health impacts during handling, feeding, and storing. Thus, the additive or sealing composition provides more convenience for the users.

In order to provide a good flowability, the aqueous additive or sealing composition preferably has a solid content of the aqueous admixture composition between 11 and 70 weight percent. Those components which are soluble in water are not considered to be included in the solid content. The thus obtained water suspension or slurry contains silica-based materials, mainly in form of a water insoluble powder, and the water-soluble carbonates or hydrogen carbonates in an admixture which can stably exist for a certain period. Even though silica-based materials have a big difference in their density (for instance about 2.2 to 2.5 g/cm³ for silica fume) compared to water, the aqueous additive or sealing composition described herein could be stabilized in slurry form by selecting a suitable thickening agent as defined above. Preferred thickening agents are xanthan gum or diutan gum, for example.

In further embodiments, the stabilizing effect as described above with regard to the dispersant could be alternatively or further improved by additional optional components. The aqueous additive or sealing composition may further comprise one or more of the following components selected of defoaming agents, retarding agents, accelerators, and shrinkage reducing agents. Other common additives or ingredients for concrete or mortar mixtures may be comprised as well in order to adjust the additive or sealing composition for its special usages.

The term dispersant as used throughout this specification includes, among others, those chemicals that also function as a plasticizer, water reducer, high range water reducer, fluidizer, antifiocculating agent, or superplasticizer for cementitious compositions. Without limitation, and only by way of illustration, suitable dispersants include polycarboxylates (including polycarboxylate ethers—PCE), polyaryl ethers (PAE), beta-naphthalene sulfonate formaldehyde polycondensates (BNS), including their alkali metal salts and earth alkali metal salts.

Illustrative examples of these dispersants are:
comb polymers having a carbon-containing backbone to which are attached pendant cement-anchoring groups and polyether side chains,
non-ionic comb polymers having a carbon-containing backbone to which are attached pendant hydrolysable groups and polyether side chains, the hydrolysable groups upon hydrolysis releasing cement-anchoring groups,
colloidally disperse preparations of polyvalent metal cations, such as Al³⁺, Fe³⁺ or Fe²⁺ and a polymeric dispersant which comprises anionic and/or anionogenic groups and polyether side chains, and the polyvalent metal cation is present in a superstoichiometric quantity, calculated as cation equivalents, based on the sum of the anionic and anionogenic groups of the polymeric dispersant,
sulfonated melamine-formaldehyde condensates,
lignosulfonates,
sulfonated ketone-formaldehyde condensates,
sulfonated naphthalene-formaldehyde condensates,
phosphonate containing dispersants,
phosphate containing dispersants, and
mixtures thereof.

Comb polymers having a carbon-containing backbone to which are attached pendant cement-anchoring groups and polyether side chains are particularly preferred. The cement-anchoring groups are anionic and/or anionogenic groups such as carboxylic groups, phosphonic or phosphoric acid groups or their anions. Anionogenic groups are the acid groups present in the polymeric dispersant, which can be transformed to the respective anionic group under alkaline conditions.

Preferably, the structural unit comprising anionic and/or anionogenic groups is one of the general formulae (Ia), (Ib), (Ic) and/or (Id):

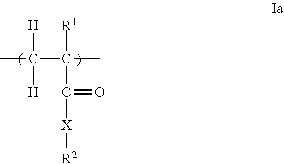

wherein
R¹ is H, C₁-C₄ alkyl, CH₂COOH or CH₂CO—X—R^{3A}, preferably H or methyl;
X is NH—(Cₙ₁H₂ₙ₁) or O—(Cₙ₁H₂ₙ₁) with n1=1, 2, 3 or 4, or a chemical bond, the nitrogen atom or the oxygen atom being bonded to the CO group;
R² is OM, PO₃M₂, or O—PO₃M₂; with the proviso that X is a chemical bond if R² is OM;
R^{3A} is PO₃M₂, or O—PO₃M₂;

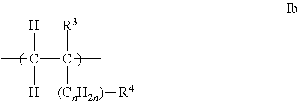

wherein
R³ is H or C₁-C₄ alkyl, preferably H or methyl;
n is 0, 1, 2, 3 or 4;
R⁴ is PO₃M₂, or O—PO₃M₂;

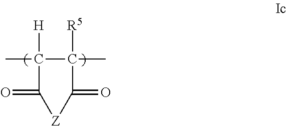

wherein
R⁵ is H or C₁-C₄ alkyl, preferably H;
Z is O or NR⁷;
R⁷ is H, (Cₙ₁H₂ₙ₁)—OH, (Cₙ₁H₂ₙ₁)—PO₃M₂(Cₙ₁H₂ₙ₁)—OPO₃M₂, (C₆H₄)—PO₃M₂, or (C₆H₄)—OPO₃M₂, and
n1 is 1, 2, 3 or 4;

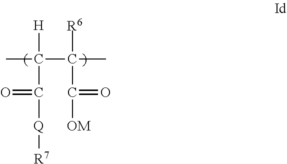

wherein
R⁶ is H or C₁-C₄ alkyl, preferably H;
Q is NR⁷ or O;
R⁷ is H, (Cₙ₁H₂ₙ₁)—OH, (Cₙ₁H₂ₙ₁)—PO₃M₂, (Cₙ₁H₂ₙ₁)—OPO₃M₂, (C₆H₄)—PO₃M₂, or (C₆H₄)—OPO₃M₂,
n1 is 1, 2, 3 or 4; and
where each M independently is H or a cation equivalent.

Preferably, the structural unit comprising a polyether side chain is one of the general formulae (IIa), (IIb), (IIc) and/or (IId):

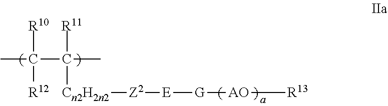

wherein
R¹⁰, R¹¹ and R¹² independently of one another are H or C₁-C₄ alkyl, preferably H or methyl;
Z² is O or S;
E is C₂-C₆ alkylene, cyclohexylene, CH₂—C₆H₁₀, 1,2-phenylene, 1,3-phenylene or 1,4-phenylene;
G is O, NH or CO—NH; or
E and G together are a chemical bond;
A is C₂-C₅ alkylene or CH₂CH(C₆H₅), preferably C₂-C₃ alkylene;
n2 is 0, 1, 2, 3, 4 or 5;
a is an integer from 2 to 350, preferably 10 to 150, more preferably 20 to 100;
R¹³ is H, an unbranched or branched C₁-C₄ alkyl group, CO—NH₂ or COCH₃;

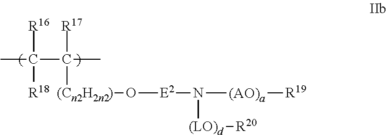

wherein
R¹⁶, R¹⁷ and R¹⁸ independently of one another are H or C₁-C₄ alkyl, preferably H;
E² is C₂-C₆ alkylene, cyclohexylene, CH₂—C₆H₁₀, 1,2-phenylene, 1,3-phenylene, or 1,4-phenylene, or is a chemical bond;
A is C₂-C₅ alkylene or CH₂CH(C₆H₅), preferably C₂-C₃ alkylene;
n2 is 0, 1, 2, 3, 4 or 5;
L is C₂-C₅ alkylene or CH₂CH(C₆H₅), preferably C₂-C₃ alkylene;
a is an integer from 2 to 350, preferably 10 to 150, more preferably 20 to 100;
d is an integer from 1 to 350, preferably 10 to 150, more preferably 20 to 100;
R¹⁹ is H or C₁-C₄ alkyl; and
R²⁰ is H or C₁-C₄ alkyl;

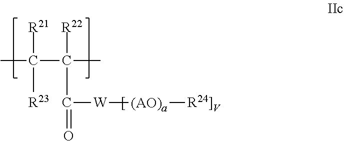

wherein
R²¹, R²² and R²³ independently are H or C₁-C₄ alkyl, preferably H;
W is O, NR²⁵, or is N;
V is 1 if W═O or NR²⁵, and is 2 if W═N;
A is C₂-C₅ alkylene or CH₂CH(C₆H₅), preferably C₂-C₃ alkylene;
a is an integer from 2 to 350, preferably 10 to 150, more preferably 20 to 100;
R²⁴ is H or C₁-C₄ alkyl;
R²⁵ is H or C₁-C₄ alkyl;

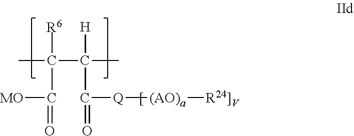

wherein
R⁶ is H or C₁-C₄ alkyl, preferably H;
Q is NR¹⁰, N or O;
V is 1 if Q═O or NR¹⁰ and is 2 if Q═N;
R¹⁰ is H or C₁-C₄ alkyl;
R²⁴ is H or C₁-C₄ alkyl;
A is C₂-C₅ alkylene or CH₂CH(C₆H₅), preferably C₂-C₃ alkylene; and
a is an integer from 2 to 350, preferably 10 to 150, more preferably 20 to 100;
   where each M independently is H or a cation equivalent.

The molar ratio of structural units (I) to structural units (II) varies from 1:3 to about 10:1, preferably 1:1 to 10:1, more preferably 3:1 to 6:1. The polymeric dispersants comprising structural units (I) and (II) can be prepared by conventional methods, for example by free radical polymerization or controlled radical polymerization. The preparation of the dispersants is, for example, described in EP 0 894 811, EP 1 851 256, EP 2 463 314, and EP 0 753 488.

A number of useful dispersants contain carboxyl groups, salts thereof or hydrolysable groups releasing carboxyl groups upon hydrolysis. Preferably, the milliequivalent number of carboxyl groups contained in these dispersants (or of carboxyl groups releasable upon hydrolysis of hydrolysable groups contained in the dispersant) is lower than 3.0 meq/g, assuming all the carboxyl groups to be in unneutralized form.

More preferably, the dispersant is selected from the group of polycarboxylate ethers (PCEs). In PCEs, the anionic groups are carboxylic groups and/or carboxylate groups. The PCE is preferably obtainable by radical copolymerization of a polyether macromonomer and a monomer comprising anionic and/or anionogenic groups. Preferably, at least 45 mol-%, preferably at least 80 mol-% of all structural units constituting the copolymer are structural units of the polyether macromonomer or the monomer comprising anionic and/or anionogenic groups. The PCEs have preferred side chain lengths of 1,000 to 6,000 Da, and an average molar weight of about 10,000-60,000 g/mol. The molecular weight of the naphthalenesulfonic acid polycondensate can suitably be determined by gel permeation chromatography (GPC) on a stationary phase under suitable conditions like those as described later herein.

A further class of suitable comb polymers having a carbon-containing backbone to which are attached pendant cement-anchoring groups and polyether side chains comprise structural units (III) and (IV):

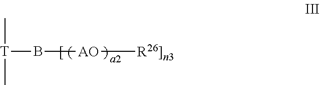

wherein
T is phenyl, naphthyl or heteroaryl having 5 to 10 ring atoms, of which 1 or 2 atoms are heteroatoms selected from N, O and S;
n3 is 1 or 2;
B is N, NH or O, with the proviso that n3 is 2 if B is N and n3 is 1 if B is NH or O;
A is C₂-C₅ alkylene or CH₂CH(C₆H₅), preferably C₂-C₃ alkylene;
a2 is an integer from 1 to 300;
R²⁶ is H, C₁-C₁₀ alkyl, C₅-C₅ cycloalkyl, aryl, or heteroaryl having 5 to 10 ring atoms, of which 1 or 2 atoms are heteroatoms selected from N, O and S;
   where the structural unit (IV) is selected from the structural units (IVa) and (IVb):

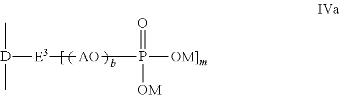

wherein
D is phenyl, naphthyl or heteroaryl having 5 to 10 ring atoms, of which 1 or 2 atoms are heteroatoms selected from N, O and S;
E³ is N, NH or O, with the proviso that m is 2 if E³ is N and m is 1 if E³ is NH or O;
A is C₂-C₅ alkylene or CH₂CH(C₆H₅), preferably C₂-C₃ alkylene;
b is an integer from 0 to 300;
M independently is H or a cation equivalent;

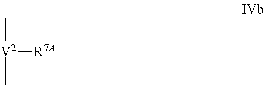

wherein
V² is phenyl or naphthyl and is optionally substituted by 1 or two radicals selected from R⁸, OH, OR⁸, (CO)R⁸, COOM, COOR⁸, SO³R⁸ and NO₂;
R^{7A} is COOM, OCH₂COOM, SO₃M or OPO₃M₂;
M is H or a cation equivalent; and
R⁸ is C₁-C₄ alkyl, phenyl, naphthyl, phenyl-C₁-C₄ alkyl or C₁-C₄ alkylphenyl.

Polymers comprising structural units (III) and (IV) are obtainable by polycondensation of an aromatic or heteroaromatic compound having a polyoxyalkylene group attached to the aromatic or heteroaromatic core, an aromatic compound having a carboxylic, sulfonic or phosphate moiety, preferably phosphate moiety, and an aldehyde compound such as formaldehyde.

In an embodiment, the dispersant is a non-ionic comb polymer having a carbon-containing backbone to which are attached pendant hydrolysable groups and polyether side chains, the hydrolysable groups upon hydrolysis releasing cement-anchoring groups. Conveniently, the structural unit comprising a polyether side chain is one of the general formulae (IIa), (IIb), (IIc) and/or (IId) discussed above. The structural unit having pendant hydrolysable groups is preferably derived from acrylic acid ester monomers, more preferably hydroxyalkyl acrylic monoesters and/or hydroxyalkyl diesters, most preferably hydroxypropyl acrylate and/or hydroxyethyl acrylate. The ester functionality will hydrolyze to (deprotonated) acid groups upon exposure to water at preferably alkaline pH, which is provided by mixing the cementitious binder with water, and the resulting acid functional groups will then form complexes with the cement component.

In one embodiment, the dispersant is selected from colloidally disperse preparations of polyvalent metal cations, such as Al³⁺, Fe³⁺ or Fe²⁺, and a polymeric dispersant which comprises anionic and/or anionogenic groups and polyether side chains. The polyvalent metal cation is present in a superstoichiometric quantity, calculated as cation equivalents, based on the sum of the anionic and anionogenic groups of the polymeric dispersant. Such dispersants are described in further detail in WO 2014/013077 A1, which is incorporated by reference herein.

Suitable sulfonated melamine-formaldehyde condensates are of the kind frequently used as plasticizers for hydraulic binders (also referred to as MFS resins). Sulfonated melamine-formaldehyde condensates and their preparation are described in, for example, CA 2 172 004 A1, DE 44 11 797 A1, U.S. Pat. Nos. 4,430,469, 6,555,683 and CH 686 186 and also in Ullmann's Encyclopedia of Industrial Chemistry, 5th Ed., vol. A2, page 131, and Concrete Admixtures Handbook—Properties, Science and Technology, 2. Ed., pages 411, 412. Preferred sulfonated melamine-formaldehyde condensates encompass (greatly simplified and idealized) units of the formula

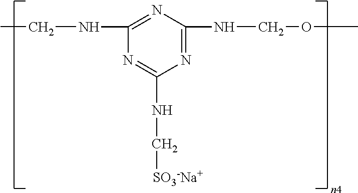

in which n4 stands generally for 10 to 300. The molar weight is situated preferably in the range from 2,500 to 80,000. Additionally, to the sulfonated melamine units it is possible for other monomers to be incorporated by condensation. Particularly suitable is urea. Moreover, further aromatic units as well may be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. An example of melaminesulfonate-formaldehyde condensates are the Melment® products distributed by Master Builders Solutions Deutschland GmbH.

Suitable lignosulfonates are products which are obtained as by-products in the paper industry. They are described in Ullmann's Encyclopedia of Industrial Chemistry, 5th Ed., vol. A8, pages 586, 587. They include units of the highly simplified and idealizing formula

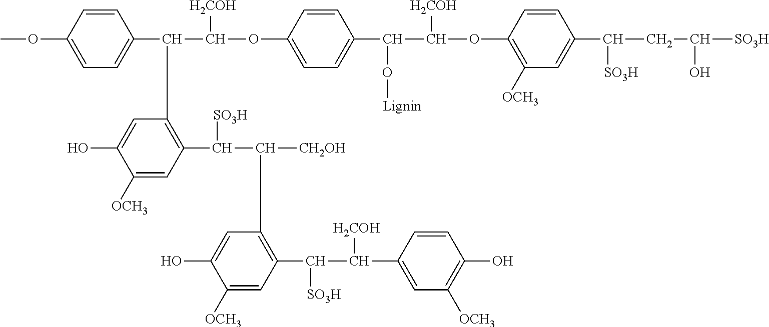

Lignosulfonates have molar weights of between 2000 and 100 000 g/mol. In general, they are present in the form of their sodium, calcium and/or magnesium salts. Examples of suitable lignosulfonates are the Borresperse products distributed by Borregaard LignoTech, Norway.

Suitable sulfonated ketone-formaldehyde condensates are products incorporating a monoketone or diketone as ketone component, preferably acetone, butanone, pentanone, hexanone or cyclohexanone. Condensates of this kind are known and are described in WO 2009/103579, for example. Sulfonated acetone-formaldehyde condensates are preferred. They generally comprise units of the formula (according to J. Plank et al., J. Appl. Poly. Sci. 2009, 2018-2024):

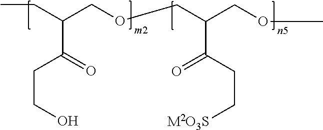

where m2 and n5 are generally each 10 to 250, M₂ is an alkali metal ion, such as Na⁺, and the ratio m2:n5 is in general in the range from about 3:1 to about 1:3, more particularly about 1.2:1 to 1:1.2. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable sulfonated acetone-formaldehyde condensates are the Melcret KlL products distributed by Master Builders Solutions Deutschland GmbH.

Suitable sulfonated naphthalene-formaldehyde condensates are products obtained by sulfonation of naphthalene and subsequent polycondensation with formaldehyde. They are described in references including Concrete Admixtures Handbook—Properties, Science and Technology, 2^{nd} Ed., pages 411-413 and in Ullmann's Encyclopedia of Industrial Chemistry, 5^{th} Ed., vol. A8, pages 587, 588. They comprise units of the formula

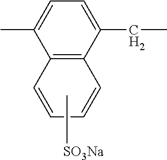

Typically, molar weights (Mw) of between 1000 and 50.000 g/mol are obtained. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable sulfonated β-naphthalene-formaldehyde condensates are the Melcret 500 L products distributed by Master Builders Solutions Deutschland GmbH.

Generally, phosphonate containing dispersants incorporate phosphonate groups and polyether side groups.

Suitable phosphonate containing dispersants are those according to the following formula

R—(OA²)ₙ₆-N—[CH₂—PO(OM³)₂]₂
wherein
R is H or a hydrocarbon residue, preferably a C₁-C₁₅ alkyl radical,
A² is independently C₂-C₁₅ alkylene, preferably ethylene and/or propylene, most preferably ethylene,
n6 is an integer from 5 to 500, preferably 10 to 200, most preferably 10 to 100, and
M³ is H, an alkali metal, ½ alkaline earth metal and/or an amine.

Preferred examples of polyaryl ether (PAE) dispersants have a side chain length of 1,000-5,000 Da and a molar weight of about 10,000-60,000 g/mol.

An illustrative example of a preferred beta-naphthalene sulfonate formaldehyde polycondensate (BNS) is a naphthalenesulfonic acid polycondensate obtainable by a condensation reaction of:
i-1) a naphthalene sulfonic acid,
i-2) an alkoxylated hydroxyaryl compound having a polyoxyalkylene chain with 3 to 130 oxyalkylene units, and
i-3) formaldehyde, in a weight ratio of i-1):i-2) of 95:5 to 60:40, preferably 85:15 to 60:40, more preferably 75:25 to 60:40.

A further example of a preferred dispersant is a sodium salt of a 2-naphthalene sulfonic acid formaldehyde polycondensate obtained by a polymerization of formaldehyde with alpha-phenyl-omega-hydroxypoly(oxy-1,2-ethanediyl).

Preferred naphthalenesulfonic acid polycondensates (BNS) are obtainable by a condensation reaction of:
i) a naphthalenesulfonic acid,
ii) an alkoxylated hydroxyaryl compound having a polyoxyalkylene chain with 3 to 130 oxyalkylene units, and
iii) formaldehyde.

The naphthalenesulfonic acid compound i) may be selected from naphthalene-1-sulfonic acid, naphthalene-2-sulfonic acid, and a mixture thereof. Naphthalene-2-sulfonic acid is preferred. The naphthalenesulfonic acid compound i) is an important intermediate in the manufacture of dyes and other chemicals. It is commercially available and is manufactured on an industrial scale by a sulfonation reaction of naphthalene with a suitable sulfonating agent such as sulfuric acid. The product of the sulfonation reaction may contain minor amounts of unreacted naphthalene which typically do not interfere with subsequent reactions and which therefore are not removed.

The alkoxylated hydroxyaryl compound ii) is a hydroxyaryl compound having a polyoxyalkylene chain with 3 to 130, preferably 5 to 100, more preferably 8 to 80 oxyalkylene units.

Herein, the term “alkoxylated hydroxyaryl compound” denotes a compound having an aromatic core and at least one hydroxyl group directly attached to the aromatic core. The alkoxylated hydroxyaryl compound may have one or more further substituents as long as the presence of such substituents does not interfere with the condensation reaction of the alkoxylated hydroxyaryl compound ii) and formaldehyde iii). In an embodiment, the hydroxyaryl compound is selected from unsubstituted or monosubstituted phenols, and unsubstituted or monosubstituted naphthols. Suitably, the phenols and naphthols may be monosubstituted with a substituent selected from alkyl groups and carboxylic groups. Suitable naphthols are selected from 1-naphthol and 2-naphthol. Suitable alkyl-substituted phenols are selected from ortho-cresol, meta-cresol and para-cresol. Suitable carboxylic-substituted phenols are selected from gallic acid and salicylic acid.

Herein, the term “oxyalkylene units” refers to a repeating unit of general formula (A-1):

-[—R—O—]- (A-1)

wherein R denotes a linear or branched alkylene unit having at least 2 carbon atoms, preferably 2 to 4 carbon atoms. The polyoxyalkylene chain may comprise identical or different oxyalkylene units. Different oxyalkylene units may be arranged either in a random or a block-wise fashion. Preferably, the oxyalkylene unit is an oxyethylene group (—CH₂—CH₂—O—) and/or an oxypropylene group (—CH(CH₃)—CH₂—O— and/or —CH₂—CH(CH₃)—O—), preferably an oxyethylene group.

The alkoxylated hydroxyaryl compounds ii) may be obtained by reaction of hydroxyaryl compounds with alkylene oxides such as ethylene oxide or propylene oxide. The alkylene oxides introduce one or more divalent oxyalkylene groups into the hydroxyaryl compounds, e.g. into the Construction Research & Technology GmbH phenol molecule. Such alkylene oxide residue is then interposed between the hydroxyl group oxygen atom and its hydrogen atom.

Generally, such an alkoxylated compound may be a single compound. However, usually, it is a mixture of compounds in which the numbers of oxyalkylene groups in the compounds are present as a distribution. That is that the number of 3 to 130 oxyalkylene units per polyoxyalkylene chain represents an average value of oxyalkylene units per polyoxyalkylene chain.

In an embodiment, the polyoxyalkylene units comprise at least 60 mol-%, preferably at least 85 mol-%, more preferably at least 95 mol-% of oxyethylene units.

In another embodiment, the alkoxylated hydroxyaryl compound ii) is an ethoxylated phenol. The term “ethoxylated phenol” denotes a hydroxyaryl compound that has been reacted with ethylene oxide to yield a polyoxyalkylene chain consisting of 100% oxyethylene units.

Suitably, such ethoxylated phenol is prepared by an ethoxylation reaction of phenol, or phenoxyethanol using ethylene oxide. Generally, such a phenoxyethanol precursor may be produced by a hydroxyethylation reaction of phenol using ethylene oxide, e.g. by a Williamson ether synthesis. Said phenoxyethanol precursor carries a hydroxyethyl moiety at the phenolic hydroxyl group oxygen atom at which a (poly)-oxyethylene chain may subsequently be attached.

The naphthalenesulfonic acid i) and the alkoxylated hydroxyaryl compound ii) are reacted in a weight ratio of i):ii) of 95:5 to 60:40, preferably 95:5 to 75:25, more preferably 95:5 to 85:15.

Suitably, the naphthalenesulfonic acid polycondensate has a weight-average molecular weight of 2,000 to 60,000 g/mol, preferably 3,000 to 40,000 g/mol, more preferably 3,000 to 12,000 g/mol. The molecular weight of the naphthalenesulfonic acid polycondensate is suitably determined by gel permeation chromatography (GPC) on a stationary phase containing sulfonated styrene-divinylbenzene with an eluent of 80 vol.-% of an aqueous solution of Na₂HPO₄ (0.07 mol/L) and 20 vol.-% of acetonitrile after calibration with polystyrene sulfonate standards.

For the preparation of the naphthalenesulfonic acid polycondensate, the above-described naphthalenesulfonic acid i) and the alkoxylated hydroxyaryl compound ii) are reacted with formaldehyde iii). The naphthalenesulfonic acid i-1) may be prepared in situ by reacting naphthalene and sulfuric acid, and reacted with the alkoxylated hydroxyaryl compound i-2) and formaldehyde i-3). Suitably, the formaldehyde iii) is added in form of paraformaldehyde or an aqueous formaldehyde solution, e.g. having a formaldehyde content of 25% to 37%. Formaldehyde iii) is present in at least a stoichiometric amount, that is, formaldehyde iii) is used in a molar amount equal to the sum of the molar amounts of the naphthalenesulfonic acid i) and the alkoxylated hydroxyaryl compound ii). Formaldehyde iii) may be used in excess of the stoichiometric amount.

The condensation reaction of the naphthalenesulfonic acid i), the alkoxylated hydroxyaryl compound ii) and formaldehyde iii) can be carried out according to processes known per se.

For carrying out the condensation process, the naphthalenesulfonic acid i) and the alkoxylated hydroxyaryl compound ii), in predetermined amounts, are mixed with in water, preferably in a sealed pressure reactor such as an autoclave. As described above, alternatively, naphthalene and sulfuric acid are mixed together with the alkoxylated hydroxyaryl compound ii), in predetermined amounts, and water. Suitably, the amount of water is adjusted in a way that the viscosity of the reaction mixture may be controlled such that the reaction mixture remains stirrable during the whole condensation process. When naphthalenesulfonic acid i) is prepared in situ, naphthalene is reacted with sulfuric acid, the mixture is cooled, and diluted with water. Then, the alkoxylated hydroxyaryl compound ii) is added as described above. Generally, the condensation process is carried out under acidic conditions. In the event that the existing acidity of the naphthalenesulfonic acid, or, in the event that the naphthalenesulfonic acid i-1) is prepared in situ, from the sulfuric acid, is not sufficient for carrying out the condensation process, an additional acid, e.g. sulfuric acid or the like, may be added to the reaction mixture in an amount such that the pH of the reaction mixture is in a range for successfully carrying out the condensation process. For adding a predetermined amount of formaldehyde iii) to the resulting mixture, the formaldehyde source and, optionally, water, are dropwise added to the mixture of i) and ii) in water at a temperature of 100 to 110° C. over a timespan of 2.5 to 3.5 hours while stirring. After completion of the dropwise addition, the mixture is heated to a temperature of 110 to 120° C. for 3 to 5 hours while stirring. The polycondensation reaction is preferably carried out in a sealed pressure reactor such as an autoclave. Then, the reaction mixture is cooled to about 80° C., and excess amounts of a base, e.g. sodium hydroxide, are added. In the event that no solid precipitate is detected in the resulting reaction mixture, no further work-up is necessary. Otherwise, the reaction mixture is suitably filtered in order to remove the solid precipitates.

Suitable contents of dispersants as described before in the aqueous additive or sealing composition are in the range of about 0.1 to 5 weight percent, based on the weight of the additive or sealing composition.

Retarding agents which may optionally comprised in the additive or sealing composition are used to retard, delay, or slow the rate of setting of concrete. Retarding agents can be added to the concrete mix upon initial batching or sometimes after the hydration process has begun. Retarding agents are used to offset the accelerating effect of hot weather on the setting of concrete or delay the initial set of concrete or grout when difficult conditions of placement occur, or problems of delivery to the job site, or to allow time for special finishing processes or to aid in the reclamation of concrete left over at the end of the workday. Without limitation, and only by way of illustration, suitable retarding agents include lignosulfonates, hydroxylated carboxylic acids, lignin, borax, gluconic, tartaric and other organic acids and their corresponding salts, phosphonates, certain carbohydrates and mixtures thereof.

Suitable contents of the main components of the aqueous additive or sealing composition are comprised in about 5 to 25 weight-% for the water-soluble salt of carbonate or hydrogen carbonate, about 5 to 35 weight-% for the silica-based material, and about 0.1 to 5 weight-% for the at least one thickening agent, based on the total weight of the aqueous additive or sealing composition. During the preparation of the aqueous additive or sealing composition, a sufficient viscosity may be achieved by adjusting the content of the thickening agent to not more than 2.5 weight-%, preferably about 0.1 to 2.0 weight-%. Exemplary upper limits of contents of powdered xanthan gum, diutan gum, or guar gum in an aqueous mixture or in the composition as described herein may be about 1.0 weight-% or 0.7 weight-% because of increased viscosity levels of the resultant mixture. Higher contents of thickening agents may extend the mixing time to provide sufficient homogeneity in the slurry mixture, may decrease the pumpability, or may affect (i.e. lower) the suitability for brush application of the composition to cementitious structures, for example. Therefore, these ranges are illustrative examples of suitable ranges but have to be determined for any combination of components used. Higher amounts of additional components may have an influence on these amounts as well.

Furthermore, disclosed is a method of manufacturing an aqueous additive or sealing composition for cementitious compositions. The method comprises mixing a water-soluble salt of carbonate or hydrogen carbonate, a silica-based material, a dispersant, at least one thickening agent and water. Mixing is carried out in a suitable mixer as long as an aqueous suspension has been prepared. The dispersant may be optional in some embodiments only. If a dispersant is present, it may comprise one or more polycarboxylate ethers, polyaryl ethers, and beta-naphthalenesulfonate formaldehyde polycondensates, sulfonated ketone-formaldehyde condensates, lignosulfonates, melamines, and their grafted derivates, or any combination thereof as described herein before in greater detail. The at least one thickening agent is selected from polymeric polyalcohols, polyanionic thickening agents, and neutral synthetic thickening agents. Exemplified thickening agents comprise one or more of the following: xanthan gum, diutan gum, guar gum, starch, cellulose, polyacrylamide, polyvinyl alcohol, and water-soluble salts of polycarboxylic acid, for example polyacrylic acid, which are described in more detail regarding the aqueous additive or sealing composition herein.

The method may involve dispersing the silica-based material such as silica fume powder and the water-soluble salt in a suitable amount of water to form an aqueous dispersion, thereby solving the salt therein. The at least one thickening agent is added to the dispersion of silica-based material in water, and the composition is mixed until a stable suspension or slurry is obtained. Optionally, suitable dispersants or other components may be mixed or suspended into the slurry at their suitable dosages to further stabilize the suspension or slurry. Besides the above components, further optional ingredients such as tartaric acid (for instance, in an amount of 0.5-2.0 wt.-%), defoaming agents such as tri-isobutyl phosphate (TIBP; for instance, in an amount of 0.001-0.02 wt.-%) or natrium gluconate powder (for instance, in an amount of 1.0-3.0 wt.-%) may be added in order to improve the overall performance of the final product especially with regard to the specific concrete or mortar applications. A shrinkage reducing agent (SRA) can be considered as an extra component to improve the drying shrinkage properties of the final products, if necessary.

The thus manufactured additive or sealing composition for cementitious compositions has a good flowability, thus, providing the users more convenience during handling, feeding, dosing, and storing compared to powdered admixtures commonly used in the market. As the obtained product is in slurry form, it is free of dust and, thus, the working environment will be much cleaner, healthier, and safer compared to the handling of commonly used powdered products.

A cementitious composition comprising the disclosed additive or sealing composition is further disclosed. The cementitious composition comprises a hydraulic cementitious binder, one or more mineral aggregates, the aqueous additive or sealing composition and, optionally, a sufficient amount of water to hydrate the hydraulic binder of the cementitious composition.

As used herein, the term cement refers to any hydraulic cement. Hydraulic cements are materials that set and harden in the presence of water. Suitable non-limiting examples of hydraulic cements include Portland cement, masonry cement, alumina cement, refractory cement, magnesia cements, such as a magnesium phosphate cement, a magnesium potassium phosphate cement, calcium aluminate cement, calcium sulfoaluminate cement, calcium sulfate hemi-hydrate cement, oil well cement, ground granulated blast furnace slag, natural cement, hydraulic hydrated lime, and mixtures thereof. Portland cement, as used in the trade, means a hydraulic cement produced by pulverizing clinker, comprising of hydraulic calcium silicates, calcium aluminates, and calcium ferroaluminates, with one or more of the forms of calcium sulfate as an interground addition. Portland cements according to ASTM Cl 50 are classified as types I, II, III, IV, or V.

The cementitious composition may also include any cement admixture or additive including set accelerators, set retarders, air entraining agents, air detraining agents, corrosion inhibitors, dispersants, pigments, plasticizers, super plasticizers, wetting agents, water repellants, fibers, dampproofing agent, gas formers, permeability reducers, pumping aids, fungicidal admixtures, germicidal admixtures, insecticidal admixtures, bonding admixtures, strength enhancing agents, shrinkage reducing agents, aggregates, pozzolans, and mixtures thereof.

In preferred embodiments, the cementitious composition may be concrete or mortar. In these embodiments, the content of the aqueous additive composition is suitably adjusted within about 0.1 to 3.0 weight percent, more preferably between about 0.5 to about 2.0 weight percent, by weight of the hydraulic cementitious binder. The content of the solid components of the additive composition may, therefore be, in the range of 0.1 to 2.0 weight percent, by weight of the hydraulic cementitious binder in the overall cementitious composition.

As described before, the aqueous additive or sealing composition in slurry form may sufficiently be homogenized into mortar or concrete when preparing the cementitious composition as described above.

According to a further embodiment, a method of preparing a cementitious structure is described, comprising the steps of preparing a cementitious composition as defined herein, placing the prepared cementitious composition at a desired location, and allowing the cementitious composition to harden. The aqueous additive or sealing composition comprised in the cementitious structure is suitable to prepare concrete with improved properties such as an improved mid age and late age compressive strength. This is assumed to be a result of the contained silica-based material such as silica fume in the aqueous additive or sealing composition. When being used as admixture in the cementitious compositions, the aqueous additive or sealing composition let the concrete be denser due to the blocking of mini pores. Especially the silica-based material such as silica fume may act as crystal growth seeds and is assumed to be responsible for the blocking of the mini pores. Moreover, the aqueous additive or sealing composition is adjusted to allow growth of crystals during the hardening of the cement. This allows a more densified concrete structure having a low permeability for water. In addition, the crystalline waterproofing admixture is preferentially used for cementitious compositions for structures that will be exposed to moisture, salt, salt water, wicking, or water under hydrostatic pressure. Prevention of water-related problems such as water-migration, freeze-and-thawing damage, corrosion, carbonation, and efflorescence are main reasons for the use of crystalline waterproofing admixtures. More particularly, the reduced concrete water permeability also hinders or prevents other harmful substances, such as chemical substances including chloride or sulfate ions, to permeate into the surface region of the cementitious structure. Thus, the concrete is made more durable against reactive chemicals by reducing the amount or rate of moisture and chemical liquids entering the concrete and the reinforcement structures.

Alternatively, the aqueous additive or sealing composition may be used in a method of treating a surface of a cementitious structure. This method comprises the steps of applying the aqueous sealing composition as described herein as surface treatment agent or coating material on the surface of a cementitious structure. The cementitious structure may be freshly prepared or already hardened or altered after long use. As such a sealing composition, it may be used for increasing water permeability due to blocking mini pores at or near the surface of the cementitious structure by crystal growth of water-insoluble calcium carbonates or bicarbonates. The aqueous additive or sealing composition as described herein is, thus, used as source of water-soluble carbonates or hydrogen carbonates together with the silica-based component and thickeners. In case the cementitious structure has some cracks, the composition can be used to bridge or heal the cracks when placed in the aqueous composition for a sufficient duration such that crystals of calcium carbonate may be grown in the cracks. The reason of the so called “self-healing” property is based on the formation of insoluble calcium carbonate crystals as soon as the aqueous composition with the water-soluble carbonate or hydrogen carbonate salts is combined with calcium ions which, for example, are solved from a hardened cementitious structure at its surface when being placed in a water bath for a suitable duration.

At the same time, it has been observed that the aqueous additive or sealing composition when being used in one of the methods as described herein improves the cohesiveness of concrete due to the presence of silica-based materials such as silica fume powder. It is assumed that the silica-based material acts as filler and/or densifying material in the hardened concrete. Fillers typically are suitable for blocking capillaries, mini pores, and hairline cracks of the concrete mass.

In the light of the above, it has been shown that the herein described aqueous additive or sealing composition is a liquid crystalline waterproofing admixture for being used as additive for cementitious mixtures or as sealing agent for surface treating cementitious structures already after being hardened. Preferentially, the composition is used as liquid crystalline waterproofing admixture in cementitious mixtures in humid environments, structures exposed to moisture or in underwater constructions. The herein described aqueous additive or sealing composition has an equal or better performance as powdered products on the market but shows significant advantages with regard to the handling properties.

It should be understood that when a range of values is described in the present disclosure, it is intended that any and every value within the range, including the end points, is to be considered as having been disclosed. For example, the amount of a component in “a range of from about 1 to about 100” is to be read as indicating each and every possible amount of that component between 1 and 100. It is to be understood that the inventors appreciate and understand that any and all amounts of components within the range of amounts of components are to be considered to have been specified, and that the inventors have possession of the entire range and all the values within the range.

In the present disclosure, the term “about” used in connection with a value is inclusive of the stated value and has the meaning dictated by the context. For example, the term “about” includes at least the degree of error associated with the measurement of the particular value. One of ordinary skill in the art would understand the term “about” is used herein to mean that an amount of “about” of a recited value results the desired degree of effectiveness in the compositions and/or methods of the present disclosure. One of ordinary skill in the art would further understand that the metes and bounds of the term “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness of the composition.

### EXAMPLES

The following examples are set forth merely to further illustrate the additive or sealing composition and methods of manufacturing the additive or sealing composition, methods of preparing cementitious compositions and usages of the additive or sealing composition. The illustrative examples should not be construed as limiting the additive or sealing composition, the cementitious composition incorporating the additive composition, or the methods of making or using the additive or sealing composition in any manner.

To produce the liquid crystalline waterproofing (LCW) samples, following raw materials have been used:
1) Three types of superplasticizer samples produced in China or Italy: BNS, PAE and PCE. More specifically, BNS (40%), PCE 1¹) (56%), PCE 2²) (50%), PAE³ (50%), PAE⁴ (33%).
   1) copolymer of the monomers maleic anhydride, acrylic acid and ethoxylated hydroxy butyl vinyl ether (VOBPEG-1,100)
   2) copolymer of the monomers maleic anhydride, acrylic acid and ethoxylated hydroxy butyl vinyl ether (VOBPEG-2,000)
   3) condensation product from phenoxy ethanol phosphate, ethoxylated phenoxy ethanol (5,000) and formaldehyde at the solid content of 33%
   4) condensation product from phenoxy ethanol phosphate, ethoxylated phenoxy ethanol (5,000) and formaldehyde at the solid content of 50% (same chemistry as under³)
2) Sodium, carbonate powder (>99%), analytical grade.

Five different recipes of LCW samples (ADD 1 to ADD 5) are shown in below tables. The default batch size is 2000 g/4000 g:

ADD 1 (s.c. 36%)

| RM | Mass (kg/100 kg) | Mass (g/2000 g) |
|---|---|---|
| PAE (33%) | 2.5 | 50 |
| Na₂CO₃, powder (99%) | 12 | 320 |
| Silica fume | 22 | 400 |
| Xanthan Gum | 0.1 | 2 |
| Water | 63.40 | 1228 |
| Total | 100 | 2000 |

ADD 2 (s.c. 26%)

| RM | Mass (kg/100 kg) | Mass (g/1000 g) |
|---|---|---|
| PCE 1 - (56%) | 1.5 | 15 |
| Na₂CO₃, powder (99%) | 8 | 80 |
| Tartaric acid powder (99%) | 2 | 20 |
| Undensified silica fume U920 | 15 | 150 |
| ACRYSOL ™ ASE 60 (thickening | 0.45 | 4.5 |
| agent from Dow Chemical) | | |
| Water | 73.05 | 730.5 |
| Total | 100 | 1000 |

ADD 3 (s.c. 42%)

| RM | Mass (kg/100 kg) | Mass (g/1000 g) |
|---|---|---|
| BNS (40%) | 2.5 | 25 |
| Na₂CO₃, powder (99%) | 16 | 160 |
| Tartaric acid powder (99%) | 0.5 | 5 |
| Undensified silica fume U920 | 25 | 250 |
| Diutan gum | 0.45 | 4.5 |
| Tri-isobutyl phosphate (TiBP) | 0.01 | 0.1 |
| defoamer | | |
| Water | 55.54 | 555.4 |
| Total | 100 | 1000 |

ADD 4 (s.c. 29%)

| RM | Mass (kg/100 kg) | Mass (g/1000 g) |
|---|---|---|
| PAE (50%) | 1.7 | 17 |
| Na₂CO₃, powder (99%) | 16 | 160 |
| Tartaric acid powder (99%) | 0.9 | 9 |
| Undensified silica fume powder | 10 | 100 |
| U920 | | |
| Xanthan Gum | 0.3 | 3 |
| Tri-isobutyl phosphate (TiBP) | 0.01 | 0.1 |
| defoamer | | |
| Na gluconate powder (99%) | 1.5 | 15 |
| Water | 69.59 | 695.9 |
| Total | 100 | 1000 |

ADD 5 (39%)

| RM | Mass (kg/100 kg) | Mass (g/1000 g) |
|---|---|---|
| PCE 2 (50%) | 1.65 | 16.5 |
| Na₂CO₃, powder (99%) | 16 | 160 |
| Tartaric acid powder (99%) | 1 | 10 |
| Densified silica fume powder 920D | 19.9 | 199 |
| Xanthan Gum powder | 0.11 | 1.1 |
| Tri-isobutyl phosphate (TiBP) | 0.01 | 0.1 |
| defoamer | | |
| Na gluconate powder (99%) | 1.5 | 15 |
| Water | 59.83 | 598,3 |
| Total | 100 | 1000 |

ADD 6 (s.c. 36%)

| RM | Mass (kg/100 kg) | Mass (g/2000 g) |
|---|---|---|
| Na₂CO₃, powder (99%) | 12 | 320 |
| Silica fume | 22 | 400 |
| Xanthan Gum | 0.1 | 2 |
| Water | 65.90 | 1278 |
| Total | 100 | 2000 |

The six LCW samples have been prepared following the general procedure as described in the following based on recipe ADD 4:
1) Add a predetermined amount of water into a clean plastic container.
2) Under stirring, introduce a predetermined amount of PAE solution into the water and agitate the mixture for 2 min till the polymer solution is fully diluted (agitation speed, 500 rpm).
3) Under stirring, introduce a predetermined amount of Xanthan gum into the water, and keep mixing for 5˜10 minutes until Xanthan gum is thoroughly dissolved (agitation speed 500 rpm).
4) Add a predetermined amount of Na gluconate powder into the solution and dissolve it thoroughly under stirring for 5˜10 min (agitation speed 500 rpm).
5) Add a predetermined amount of sodium carbonate (Na₂CO₃) into the solution and dissolve it thoroughly under stirring for 5˜10 min (agitation speed can be 500˜800 rpm).
6) Slowly add a predetermined amount of L-(+)-tartaric acid into the solution, if needed at all. Air bubbles may be generated once the tartaric acid reacts with sodium carbonate, so be careful not to add tartaric acid too fast. After addition of tartaric acid is finished and after air bubble vanishes, still for 1 or 2 more minutes (agitation speed 500˜800 rpm).
7) Under stirring and with caution, slowly add a predetermined amount of silica fume powder into the solution. During the process of adding silica fume powder, one can increase the agitation speed gradually from 800 rpm to 1800 rpm, as long as the mixture will not be splashed out. When the addition of silica fume is finished, stepwise reduce the agitation speed from 1800 rpm to 1500 rpm, and keep agitating the mixture for at least 30 min. It's suggested not adjusting the speed to a very high value, otherwise air would be trapped into the mixture and foams would be formed.
8) Introduce a predetermined amount of TiBP defoamer to the mixture and agitate it for 2˜5 min (agitation speed 1500 rpm), if needed at all for avoiding excessive air intake during the preparation of the composition.
9) After finishing above steps, adjust the agitation speed from 1500 rpm to 0 rpm, and switch off the agitator.
10) Transfer the final LCW sample into a clean container. Don't seal the container immediately. Instead, one can put a flat cover on the container. Let it cool down. After placing it still overnight in the lab, seal the container and store it at room temperature for further use.

### Examples 1 and 2 and Comparative Example 1—Concrete Slump/Slump Retention Testing

The effect of the disclosed additive or sealing composition to the behavior in fresh concrete was tested by common slump tests. Concrete prepared from cement (manufactured by Onoda Cement Co.), a coarse aggregate (1-10 mm), natural sand, and water was filled in cones for slump testing. The weight contents of cement: coarse aggregate:sand:water were about 380:1110:730:190. In comparative example 1, no additive composition was used. In example 1 the additive composition ADD 1 was mixed in an amount of 1 weight percent by weight of the total concrete mixture. In example 2, the additive composition ADD 1 was mixed in an amount of 2 weight percent of the total concrete mixture.

The test of the concrete of the examples 1 and 2 with different contents of ADD 1 showed a slightly higher slump flow value as the concrete of comparative example 1 without any admixture after 5 minutes. After 30 minutes, only the concrete of example 2 had a measurable slump flow.

### Example 3 and Comparative Example 2—Self-Healing Testing

Mortar specimens (100*100*30 mm) were prepared using Ordinary Portland cement (manufactured from Hailuo), river sand, water and the above-described liquid crystalline waterproofing admixture ADD 1 in a content of 2.0 wt.-% in example 3. The mortar specimen of comparative example 2 were remained without addition of ADD 1. The mortar specimens were split into two parts (preferably in the middle of the specimens), bound together such that a crack of about 0.5 mm was maintained, and fixed by a rubber band. The thus prepared mortar specimens were water cured for at least 28 days. Different samples were stored in different containers to avoid interference among each other.

In example 3, the crack between the two mortar specimen halves was nearly closed by growth of new crystals of calcium carbonate (mostly calcite) along the bottom line of the cracks after some days. At the end of the 28 days, nearly the whole crack was healed by the components comprised in the liquid crystalline waterproofing admixture.

In comparative example 2, no self-healing property could be observed, and the two halves were still separated after 28 days period.

Thus, it has been shown that the herein described liquid crystalline waterproofing admixture compositions being effective in self-healing properties of concrete or mortar. Similar results as in example 3 with ADD 1 have been achieved with the compositions of LCW samples ADD 2, ADD 3, ADD 4, and ADD 5 in self-healing testing with a dosage of 2 wt.-%. ADD 1 achieved similar self-healing properties with a dosage of 1 wt.-%.

### Example 4 and Comparative Example 3-Water Permeability Testing

Concrete cubes (150*150*150 mm) were prepared form the same concrete mixture as in examples 1 and 2. In example 4, the liquid crystalline waterproofing admixture ADD 1 was added in a content of about 1 wt.-% based on the total weight of the concrete sample. In comparative example 3, no additive composition was added.

The test method follows BS EN 12390-8:2009. The cubes were subjected to water pressure of 0.5 MPa for 72 hours. The maximum penetration depth of water was measured and recorded. The penetration depth value was used to reflect the concrete permeability.

The penetration reduction ratio of the concrete sample in example 4 was 46% compared to the sample in comparative example 3 wherein no additive composition was used. Thus, it has been shown that the herein described liquid crystalline waterproofing admixture compositions being effective in waterproofing properties of concrete or mortar.

While the additive or sealing composition, the cementitious composition including the additive or sealing composition, and methods of manufacturing the additive or sealing and cementitious compositions have been described in connection with various illustrative embodiments, it is to be understood that other similar embodiments may be used or modifications and additions may be made to the described embodiments for performing the same function disclosed herein without deviating therefrom. The illustrative embodiments described above are not necessarily in the alternative, as various embodiments may be combined to provide the desired characteristics. Therefore, the disclosure should not be limited to any single embodiment, but rather construed in breadth and scope in accordance with the recitation of the appended claims.

1. An aqueous additive or sealing composition for cementitious compositions comprising:
a water-soluble salt of carbonate or hydrogen carbonate,
a silica-based material,
a dispersant, selected of one or more polycarboxylate ethers, polyaryl ethers, and beta-naphthalenesulfonate formaldehyde polycondensates, sulfonated ketone-formaldehyde condensates, lignosulfonates, melamines, and their grafted derivates, or any combination thereof,
at least one thickening agent selected from polymeric polyalcohols, polyanionic thickening agents, and neutral synthetic thickening agents, and
water.

2. The aqueous additive or sealing composition according to claim 1, wherein the components are suspended in form of a slurry.

3. The aqueous additive or sealing composition according to claim 1, having a solid content of the aqueous admixture composition between 11 and 70 weight-%.

4. The aqueous additive or sealing composition according to claim 1, wherein the water-soluble salt of carbonate or hydrogen carbonate is selected from the group consisting of carbonates or hydrogen carbonates of sodium, potassium, lithium, and ammonium, and any mixture thereof.

5. The aqueous additive or sealing composition according to claim 1, wherein the silica-based material meets at least one of the following parameters:
particle size is between 1 to 1000 nm,
SiO₂ content of more than 50 weight-%,
moisture content of 3.0 weight-% or less,
loss on ignition of 6.0% or less,
specific BET surface area of 15 m²/g or more, and
bulk density between 500 to 800 kg/m³.

6. The aqueous additive or sealing composition according to claim 1, wherein the silica-based material is selected from the group consisting of silica fume, fumed silica, and fly ash.

7. The aqueous additive or sealing composition according to claim 1, wherein the thickening agent is selected from xanthan gum, diutan gum, guar gum, starch, cellulose, polyacrylamide, polyvinyl alcohol, poly (methyl methacrylate) and polycarboxylic acids and their salts.

8. The aqueous additive or sealing composition according to claim 1, further comprising one or more of the following components selected of defoaming agents, retarding agents, accelerators, and shrinkage reducing agents.

9. The aqueous additive or sealing composition according to claim 1, wherein the dispersant is comprised in 0.1 to 5 weight-%.

10. The aqueous additive or sealing composition according to claim 1, wherein the at least one thickening agent is comprised in 0.1 to 2.0 weight-%.

11. The aqueous additive or sealing composition according to claim 1, wherein the water-soluble salt of carbonate or hydrogen carbonate is comprised in 5 to 25 weight-% and/or the silica-based material is comprised in 5 to 35 weight-%.

12. A method of manufacturing an aqueous additive or sealing composition for cementitious composition according to claim 1 comprising mixing the following components and providing an aqueous suspension:
a water-soluble salt of carbonate or hydrogen carbonate,
a silica-based material,
a dispersant selected of one or more polycarboxylate ethers, polyaryl ethers, and beta-naphthalenesulfonate formaldehyde polycondensates and their grafted derivates, or any combination thereof,
at least one thickening agent selected from polymeric polyalcohols, polyanionic thickening agents, and neutral synthetic thickening agents, and
water.

13. A method of manufacturing an aqueous additive or sealing composition for cementitious compositions according to claim 12, wherein the thickening agent is selected from xanthan gum, diutan gum, guar gum, starch, cellulose, polyacrylamide, polyvinyl alcohol, poly (methyl methacrylate) and polycarboxylic acids and their salts.

14. A cementitious composition comprising:
a hydraulic cementitious binder,
a mineral aggregate,
the aqueous additive composition according to claim 1, and
optionally water.

15. The cementitious composition according to claim 14, wherein the composition is concrete or mortar and the content of the aqueous additive composition is 0.1 to 2 weight-% by weight of hydraulic cementitious binder.

16. A method of preparing a cementitious structure comprising:
preparing a cementitious composition according to claim 14,
placing the prepared cementitious composition at a desired location, and
allowing the cementitious composition to harden.

17. A method of treating a surface of a cementitious structure, comprising applying the aqueous sealing composition according to 1 as surface treatment agent or coating material on the surface of a cementitious structure.
